(19) United States
(12) Patent Application Publication
(10) Pub. No.: US 2006/0090559 A1
(43) Pub. Date: May 4, 2006

(54) Low pressure and hyperpressure warning device for automotive tire

(75) Inventor: Zhixiong Yang, Quanzhou (CN)

Correspondence Address: GREER, BURNS & CRAIN, 300 S WACKER DR, 25TH FLOOR, CHICAGO, IL, 60606, US

(73) Assignee: Zhilong Technology Co., Ltd.

(21) Appl. No.: 10/981,322

(22) Filed: Nov. 4, 2004

(51) Int. Cl. G01M 17/02

(52) U.S. Cl. 73/146

(57) ABSTRACT

A low-pressure and hyperpressure warning device for an automotive tire for automotive tire includes an air pressure detector, a radio emitter, and a radio signal receiving alarm annunciator, which are all set inside the tire. The air pressure detector includes a barrel with a hollow interior, two insulating covers covering both ends of the barrel, a mobile conductive piston inside the barrel, an elastomer which is set between and joins the piston and one of the covers, and too conductive poles which are set on the covers and stretch into the barrel. The interior of the barrel is divided by the piston into an airtight constant pressure air chamber and a second air chamber which communicates with the air in the tire. The conductive pole and the piston contact the radio emitter separately. This warning device is designed to trigger the alarm when the air pressure in the tire goes too high or too low.

### TECHNOLOGICAL FIELD

This invention relates to a device which is used to check and measure the air pressure in the tire and will rise the alarm when the pressure is in the exceptional state.

### BACKGROUND TECHNOLOGY

As everyone knows, the tire is the important assembly ensuring the motor vehicle running safety. When the tire has a gas leaking or at a low air pressure, the stability of driving will be influenced. And when the motor vehicle moves at a high speed, the tire rubs against the road producing heat which make the air in the tire expand, and the pressure should exceed the normal pressure, and the tire may even go burst and leading to a traffic accident. So, measuring the inner air pressure accurately and effectively and alarming in time are very important in dispelling the hidden safety danger of the motor vehicle.

Although there are some air pressure measuring and warning device for the tire at present, the effect and the practicability are unsatisfactory because of the defect on the structure and design.

### INVENTION CONTENT

The aim of the invention is to show a low-pressure and hyperpressure warning device for automotive tire in a rational structure. The device is put inside the tire. It will rise the alarm when the air pressure in the tire goes too high or too low.

A low-pressure and hyper-pressure warning device for automotive tire comprising: an air pressure detector; a radio emitter; a radio signal receiving alarm, the character of the invention is that the air pressure detector and the radio emitter are set inside the tire; the air pressure detector comprising a barrel with a hollow interior, two insulating covers covering both ends of the barrel, a mobile conductive piston is set inside the barrel, an elastomer is set between and joint the piston and one of the covers, and the conductive pole which is set on the covers and stretch into the barrel. The interior of barrel is divided by the piston into an airtight constant pressure air chamber and an air chamber, air in air chamber communicates with the air in the tire. The conductive pole and the piston are connected with the radio emitter separately.

For connecting more convenient, the air pressure detector can be improved in ways following: the barrel is made of conductive material and is connect with the radio emitter, the interior wall of the barrel keeps in conductive touch with the piston, an obturator is set at the place the piston gets in touch with the interior wall of the barrel.

To make sure the piston and the interior wall of the barrel keep always in conductive touch, a conductive elastomer and a conductive ball are set in the trough hole on the piston. The elastomer props up and presses the ball to the interior wall of the barrel.

In a further improvement, the length the conductive poles stretch into the barrel is controllable.

When the air pressure of the tire is lower or higher than set value, the piston moves under the common function of the pressure of the two air chambers and the elasticity of the elastomer and contact with the conductive pole, thereby the radio emitter sends out signal and the radio signal receiving alarm annunciator rise the alarm when it receives the signal. As set inside the tire, the measuring part and radio sending part of the warning device work without influence of external environment, and could feel the change of the air pressure in the tire directly. It is designed in a rational structure. The actual test showing that, this warning device has good satisfactory dependability and sensitivity, especially suitable for all kinds of vehicles using the vacuum tire.

### ILLUSTRATION

Now combing the figure and instance will do further elaboration to this invention.

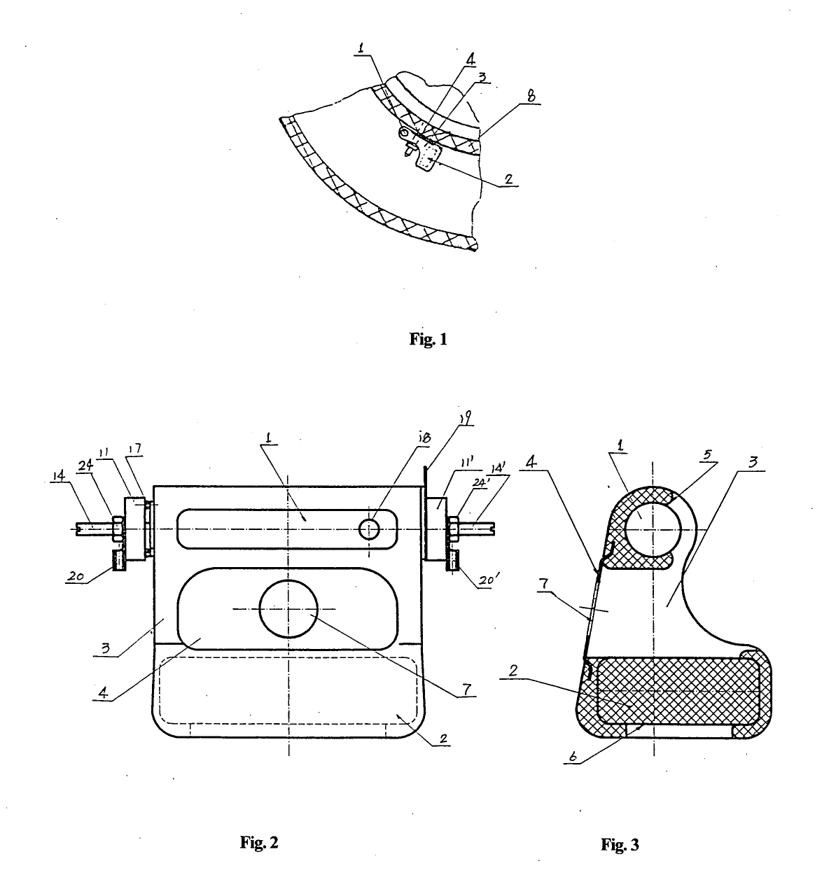

FIG. 1 is a sketch map about the low-pressure and hyperpressure warning device for automotive tire is set inside the tire.

FIG. 2 is a front view of the assembly which consist of the air pressure detector, the radio emitter and the support.

FIG. 3 is a left sectional view of FIG. 1.

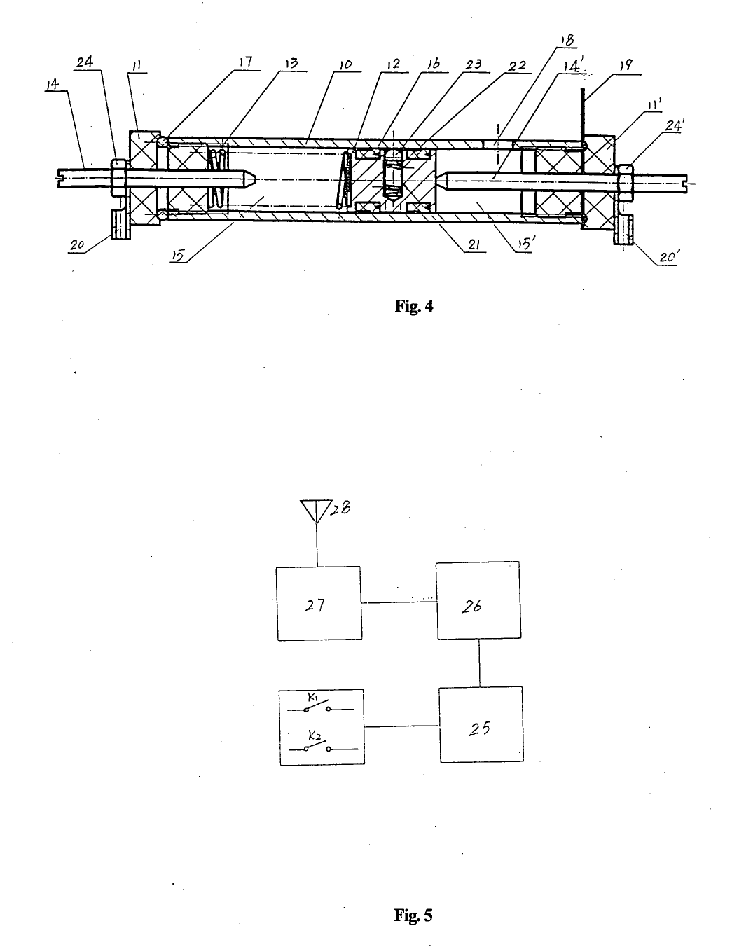

FIG. 4 is a front sectional view of the air pressure detector in the low-pressure and hyperpressure warning device.

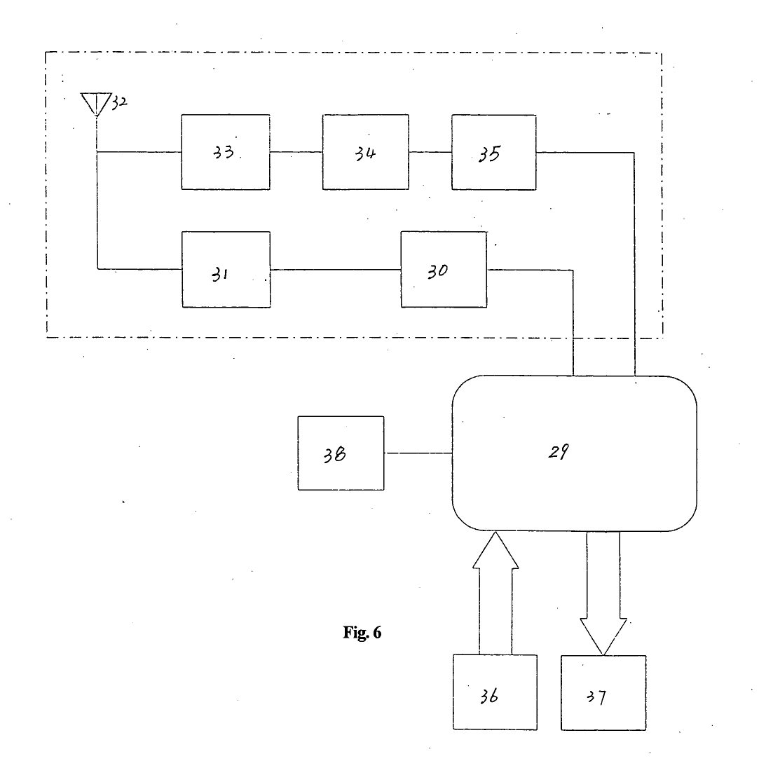

FIG. 5 is an electric schematic diagram of the radio emitter in the low-pressure and hyperpressure warning device.

FIG. 6 is a circuit diagram of radio signal receiving alarm in the low-pressure and hyperpressure warning device.

### CONCRETE METHOD

A low-pressure and hyperpressure warning device for the automotive tire includes an air pressure detector 1, a radio emitter 2, and a radio signal receiving alarm annunciator. As FIG. 2 and FIG. 3 show, the air pressure detector 1, the radio emitter 2 and the support make up an assembly. The support includes a rubber seat 3 and a rigid support board 4. The hole 5 on the rubber seat 3 is used for setting the air pressure detector 1, and the trough 6 on the rubber seat 3 is used for setting the radio emitter 2. The rubber seat 3 could reduce the influence caused by vibrations and jolts. The rigid support board 4 is fastened on the tire valve 9 in the tire 8 through the hole 7, from this way the assembly is set inside the tire 4 just as FIG. 1 shows.

As FIG. 4 shows, the air pressure detector 1 includes a conductive barrel 10 with a hollow interior, two insulating covers 11,11′ covering both ends of the barrel 10, a mobile conductive piston 12 is set inside the barrel 10, a spring 13 is set between and joint the cover 11 and the piston 12, and two conductive poles 14,14′ which are set on the covers 11,11′ stretch into the barrel 10. The interior hollow of the barrel 10 is divided into two air chambers 15, 15′ by the piston 12, and the piston 12 keeps in conductive touch with the interior wall of the barrel. An obturator 16 is set at the place the piston contact with the interior wall of the barrel, so that the air chamber 15 and 15′ could be isolated airtight. A gasket 17 is set at the place the air chamber 15 contacts with the insulating cover 11 so that the air chamber 15 become an airtight constant pressure air chamber. The air cavity 18 is set on the air chamber 15′ and enables the air in the chamber 15′ to communicate with the air in the tire, the air pressure in the chamber 15′ as same as the air pressure in the tire. The conductive wiring slices 19,20,20′ are set on the barrel 10 and conductive poles 14,14′ respectively. Conductive wiring slices are connected to the circuit of the radio emitter 2 by wire.

The trough hole 21 is set on the piston 12, and the conductive spring 22 and the ball bearing 23 are set inside the trough hole 21. The spring 22 props up the ball 23 and presses the ball bearing 23 to the interior wall of the barrel 10 so that the piston 12 keep always in conductive touch with the interior wall of the barrel 10.

When the air pressure in the tire is in usual state, the piston 12 will not move because the resultant force of the air pressure of air chamber 15 and the elasticity of the spring 13 equals the air pressure of air chamber 15′; when the air pressure in the tire goes lower than set value and in the lose pressure state, the resultant force of the air pressure of air chamber 15 and the elasticity of the spring 13 is bigger than the air pressure of air chamber 15′, so the piston 12 is promoted to move towards the air chamber 15′ so that the piston 12 gets in conductive touch with the conductive pole 14′ and the radio emitter 2 sends out signal of low-pressure. As the same reason, when the air pressure in the tire goes higher than set value, the piston 12 moves towards the air chamber 15 so that he piston 12 gets in conductive touch with the conductive pole 14, and the radio emitter 2 sends out signal of hyperpressure.

There is whorl carved on the two conductive poles 14,14′, and there are nuts 24,24′ on both covers 11,11′. So the length the conductive poles 14,14′ stretch into the barrel 10 could be adjust. The lose pressure and hyperpressure alarm valve of the tire can be set by adjust the distance between the conductive pole 14,14′ and the piston 12. FIG. 5 is a circuit diagram of the radio emitter 2. When the piston 12 touches the conductive pole 14′, switch K1 in the diagram is closed; when the piston 12 touches the conductive pole 14, switch K2 in the diagram is closed. In this way, the controller 25 sends out corresponding signals through the modulation circuit 26, the magnifying circuit 27 and the aerial 28.

The radio signal receiving alarm device should be installed at the place where is easy to be seen, just like the driver's cabin. FIG. 6 shows the circuit element of radio signal receiving alarm device, the circuit including a controller 29, a modulation circuit 30, a magnifying circuit 31, a aerial 32, a high-frequency circuit 33, a frequency conversion circuit 34, a demodulation circuit 35, a input examining circuit 36, and a output examining circuit 37. The above-mentioned circuits and method of connecting are the routine structure. Mover over, a vibrations warning circuit 38 can be set. For using more convenient, a remote controller in hand is provided.

1. A low-pressure and hyperpressure warning device for an automotive tire, comprising:
an air pressure detector;
a radio emitter;
a radio signal receiving alarm;
wherein the air pressure detector and the radio emitter are set inside the tire;
the air pressure detector comprising:
a barrel with a hollow interior;
two insulating covers covering both ends of the barrel;
a mobile conductive piston inside the barrel;
an elastomer between the piston and the one of the covers; and
two conductive poles which stretch into the barrel through the covers.

2. The low-pressure and hyperpressure warning device for an automotive tire as recited in claim 1, wherein the barrel is made of conductive material, the interior wall of the barrel keeps in conductive touch with the piston, an obturator is set at the place the piston gets in touch with the inboard wall of the barrel and the barrel and the radio emitter are connected.

3. The low-pressure and hyperpressure warning device for an automotive tire as recited in claim 1, further comprising a trough hole on the piston, the conductive elastomer and ball bearing are disposed inside the trough hole, a conductive elastomer props up the ball and presses it close to the interior wall of the barrel.

4. The low-pressure and hyperpressure warning device for an automotive tire as recited in claim 1, wherein the length the conductive poles stretch into the barrel is adjustive.

5. The low-pressure and hyperpressure warning device for an automotive tire as recited in claim 1, wherein said interior of the barrel is divided into two air chambers by the piston, a first of said chambers is an airtight constant pressure air chamber, the other chamber has an air hole through which air in said latter chamber communicates with the air in the tire.

6. The low-pressure and hyperpressure warning device for an automotive tire as recited in claim 5, wherein said conductive pole and the piston contact the radio emitter separately.

7. A low-pressure and hyperpressure warning device for an automotive tire, comprising:
an air pressure detector;
a radio emitter;
a radio signal receiving alarm;
the air pressure detector and the radio emitter are set inside the tire;
the air pressure detector comprising:
a barrel with a hollow interior;
two insulating covers covering both ends of the barrel;
a mobile conductive piston inside the barrel;
an elastomer between the piston and the one of the covers;
two conductive poles which stretch into the barrel through the covers;
said interior of the barrel is divided into two air chambers by the piston, a first of said chambers is an airtight constant pressure air chamber, a second of said chambers has an air hole through which air in said second chamber communicates with the air in the tire; and
said conductive pole and the piston contact the radio emitter separately.
